(19) United States
(12) Patent Application Publication
(10) Pub. No.: US 2018/0368428 A1
(43) Pub. Date: Dec. 27, 2018

(54) METHOD FOR DEACIDIFYING, NEUTRALIZING OR ALKALINIZING AN ACID DAIRY COMPOSITION

(71) Applicant: Compagnie Gervais Danone, Paris (FR)

(72) Inventors: Laurent Marchal, Villemoisson sur Orge (FR); François Debru, Versailles (FR)

(21) Appl. No.: 16/062,905

(22) PCT Filed: Dec. 21, 2016
(86) PCT No.: PCT/EP2016/082090

§ 371 Date: Jun. 15, 2018

(30) Foreign Application Priority Data
Dec. 23, 2015 (EP) PCT/EP2015/081138

(51) Int. Cl. A23C 9/12

(52) U.S. Cl. CPC A23C 9/1216; A23C 9/127; A23C 9/1206

(57) ABSTRACT

The present invention relates to a method for deacidifying, neutralizing or alkalinizing a starting liquid or fluid acid dairy composition, comprising: a) providing a liquid or fluid acid dairy composition comprising lactic acid; b) inoculating the composition with at least one yeast; c) incubating the inoculated composition; d) recovering a deacidified, neutralized or alkalinized liquid or fluid acid dairy composition with a reduced concentration of lactic acid.

### FIELD OF THE INVENTION

The present invention relates to a method for deacidifying, neutralizing or alkalinizing an acid dairy composition, in particular acid whey.

### TECHNOLOGICAL BACKGROUND

Strained fermented dairy products, such as strained yogurts (e.g. Greek yogurts), are obtained by a process involving fermenting a dairy material with lactic acid bacteria and a separation step. The separation step yields on one hand a concentrated strained product, and on another hand an acid whey by-product. Thus, as production and consumption of strained products increase, the production of acid whey by-products also increases. By way of example, for every 100 kg of milk used to make Greek yogurt, 66 kg ends up as acid whey by-product.

Acid whey contains valuable components such as lactose (about 37 g/L) and some whey proteins and it would be desirable to use it for the manufacture of food products, for instance as an adjunct in the manufacture of dairy products.

However, because of its acidity, acid whey currently finds low usage in food production.

As such, large quantities are to be disposed of, preferably in a nature-friendly fashion, which can also require costly treatments. Indeed, acid whey is generally too acidic to be handled by waste water treatment facilities.

In this regard, it has been proposed to neutralize acid whey with a basic material, such as calcium hydroxide or magnesium hydroxide, to a pH 6.0 (WO 2014/189519).

However, adding a basic solution to acid whey may alter certain of its constituents or their concentrations. Besides, the addition of the basic material to acid whey leads to the incorporation of new ingredients, in particular ions, such as Mg²⁺ and Ca²⁺, into the treated whey which may limit the uses thereof either for further processing or for human or animal consumption.

Accordingly, there is still a need for alternative methods of deacidifying, neutralizing or alkalinizing acid whey.

### SUMMARY OF THE INVENTION

The present invention arises from the unexpected finding, by the present inventors, that yeasts could grow in acid whey and efficiently remove lactic acid therefrom, thereby deacidifying, neutralizing or alkalinizing it, without significantly decreasing lactose concentration.

Accordingly, the present invention relates to a method for deacidifying, neutralizing or alkalinizing a starting liquid or fluid acid dairy composition, preferably while preserving lactose or minimizing lactose consumption, comprising:

a) providing a liquid or fluid acid dairy composition comprising lactic acid;
b) inoculating the composition with at least one yeast;
c) incubating the inoculated composition;
d) recovering a deacidified, neutralized or alkalinized liquid or fluid acid dairy composition with a reduced concentration of lactic acid.

The present invention also relates to a deacidified, neutralized or alkalinized liquid or fluid acid dairy composition liable to be obtained, or obtained, by the method for deacidifying, neutralizing or alkalinizing a starting liquid or fluid acid dairy composition according to the invention.

The present invention also relates to the use of a yeast for deacidifying, neutralizing or alkalinizing a starting liquid or fluid acid dairy composition, in particular by reducing the lactic acid concentration thereof.

The present invention also relates to a liquid or fluid dairy composition, in particular a deacidified, neutralized or alkalinized liquid or fluid acid composition, comprising at least one yeast selected from the group consisting of Debaryomyces hansenii and Candida utilis, lactic acid at a concentration lower than 200 mg/100 g and lactose at a concentration higher than 1 g/100 and preferably lower than 5 g/100 g.

The present invention also relates to the use of a deacidified, neutralized or alkalinized liquid or fluid acid composition as defined above in the manufacture of a food product, in particular a dairy product.

The present invention also relates to the use of a deacidified, neutralized or alkalinized liquid or fluid acid composition as defined above as a fertilizer.

The present invention also relates to the use of a deacidified, neutralized or alkalinized liquid or fluid acid composition as defined above as a culture medium, in particular a bacterial culture medium.

The present invention also relates to the use of a deacidified, neutralized or alkalinized liquid or fluid acid composition as defined for the production of fibers.

The present invention also relates to the use of a deacidified, neutralized or alkalinized liquid or fluid acid composition as defined above for the production of aromas.

The present invention also relates to the use of a deacidified, neutralized or alkalinized liquid or fluid acid composition as defined above as a pharmaceutical carrier or excipient.

### DETAILED DESCRIPTION OF THE INVENTION

### Liquid or Fluid Acid Dairy Composition

As intended herein “deacidifying, neutralizing or alkalinizing” a composition means decreasing the concentration of H⁺ ions of the composition or increasing the pH of the composition. In addition, deacidifying also has the meaning of reducing or cancelling the acidity of the composition, neutralizing also has the sense of rendering the composition neutral, and alkalinizing has the sense of increasing the alkalinity of the composition or of rendering it alkaline.

As intended herein a “dairy composition” relates to any composition comprising milk or derived from milk, for instance by lactic acid fermentation. An “acid” dairy composition according to the invention is acid, i.e. its concentration in H ions is higher than 10⁻⁷ or its pH is below 7.

Preferably the starting liquid or fluid acid dairy composition according to the invention is selected from the group consisting of acid whey, a stirred yogurt, a liquid yogurt, and a fermented dairy drink, in particular a fermented-milk drink. Most preferably the starting liquid or fluid acid dairy composition according to the invention is acid whey.

“Acid whey” is well known to one of skill in the art. Acid whey can notably be obtained by fermenting a dairy material, in particular milk, by lactic acid bacteria. Separation of the fermented dairy material yields a concentrated strained product on one hand and acid whey on the other. Acid whey is generally considered a by-product of strained products.

Derivatives of acid whey, such as (i) dehydrated and rehydrated acid whey, (ii) filtrated acid whey, in particular nanofiltrated acid whey, optionally diluted, (iii) deacidified acid whey, or (iv) refined acid whey, can be acid dairy composition according to the invention.

Preferably the starting liquid or fluid acid dairy composition according to the invention comprises lactic acid at a concentration higher than 300 mg/100 g, 400 mg/100 g, 500 mg/100 g, 600 mg/100 g, 700 mg/100 g, 800 mg/100 g, 900 mg/100 g or 1000 mg/100 g. More preferably, the starting liquid or fluid acid dairy composition according to the invention comprises lactic acid at a concentration higher than 600 mg/100 g. Preferably also, the starting acid dairy composition according to the invention comprises lactic acid at a concentration lower than 1500 mg/100 g or 1200 mg/100 g.

As intended herein the concentration of “lactic acid” is considered equivalent to the concentration of “lactate” and means the concentration of all forms of lactic acid, i.e. protonated and unprotonated D- and L-lactic acid. Unprotonated lactic acid is also called lactate. In other words, the concentration of lactic acid as intended herein is the sum of the concentration of D-lactic acid, D-lactate, L-lactic acid and L-lactate. The concentration of lactic acid can be determined by numerous methods well known to one of skill in the art, such as refractometry coupled to HPLC (High Performance Liquid Chromatography), infra-red spectroscopy, enzymatic assays, for instance based on D/L-lactacte deshydrogenase, or Nuclear Magnetic Resonance (NMR).

Preferably the pH of the starting acid dairy composition according to the invention is lower than 5.0, 4.5, 4.0, 3.5 or 3.0.

Preferably the Dornic degree (° D) of the starting acid dairy composition according to the invention is higher than 30° D, 40° D, 50° D, 60° D, 70° D, 80° D, 90° D or 100° D. More preferably, the starting acid dairy composition according to the invention comprises lactic acid at a concentration higher than 60° D. Preferably also, the starting acid dairy composition according to the invention comprises lactic acid at a concentration lower than 150° D or 120° D.

Preferably the starting liquid or fluid acid dairy composition according to the invention comprises lactose. More preferably the starting liquid or fluid acid dairy composition according to the invention comprises lactose at a concentration of at least 0.5 g/100 g, 1 g/100 g, 1.5 g/100 g, 2 g/100 g, 2.5 g/100 g, 3 g/100 g, 3.5 g/100 g, 4 g/100 g, or 4.5 g/100 g. More preferably also the starting liquid or fluid acid dairy composition according to the invention comprises lactose at a concentration lower than 10 g/100 g, 9 g/100 g, 8 g/100 g, 7 g/100 g, 6 g/100 g, or 5 g/100 g.

The concentration of lactose can be determined by numerous methods well known to one of skill in the art, such as refractometry coupled to HPLC, for instance according to the Association of Analytical Communities (AOAC) Official Method 984.12; polarimetry coupled to HPLC; or enzymatic assays, for instance based on the enzymatic hydrolysis of lactose to glucose and galactose at pH 6.6 by β-galactosidase, subsequent oxidation of the β-galactose released to galactonic acid at pH 8.6 β-galactose dehydrogenase, then followed by reduction of nicotinamide adenine dinucleotide (NAD⁺) which concentration is determined by reading the absorbance at 340 nm, in particular pursuant to the AOAC Official Method 984.15.

Preferably the starting liquid or fluid acid dairy composition according to the invention, in particular acid whey, is not enriched or added with nutrients or adjuncts useful for sustaining the growth of the at least one yeast according to the invention, such as soy-derived nutrients or adjuncts, in particular soy-derived carbohydrates.

### Deacidified, Neutralized or Alkalinized Acid Dairy Composition

Preferably the ratio of the concentration of lactic acid in the deacidified, neutralized or alkalinized liquid or fluid acid dairy composition according to the invention to the concentration of lactic acid in the starting liquid or fluid acid dairy composition is lower than 0.8, 0.7, 0.6, 0.5, 0.4, 0.3, 0.2, 0.15, 0.1 or 0.05. As should be clear to one of skill in the art, the concentrations used for calculating the ratios are expressed with the same units and are preferably determined with the same method.

Preferably the deacidified, neutralized or alkalinized liquid or fluid acid dairy composition according to the invention comprises lactic acid at a concentration lower than 300 mg/100 g, 250 mg/100 g, 200 mg/100 g, 150 mg/100 g, 100 mg/100 g or 50 mg/100 g.

Preferably the pH of the deacidified, neutralized or alkalinized liquid or fluid acid dairy composition according to the invention is higher than 5.0, 5.5, 6.0, 6.5, 7.0, 7.5, 8.0, 8.5 or 9.

Preferably the pH increase of the deacidified, neutralized or alkalinized liquid or fluid acid dairy composition according to the invention with respect to the starting liquid or fluid acid dairy composition according to the invention is of at least 0.5, 1, 1.5, 2, 2.5, 3, 3.5, 4, 4.5 or 5.

Preferably the ratio of the concentration of lactose in the deacidified, neutralized or alkalinized liquid or fluid acid dairy composition according to the invention to the concentration of lactose in the starting liquid or fluid acid dairy composition is higher than 0.6, 0.7, 0.8, 0.85, 0.9 or 0.95. As should be clear to one of skill in the art, the concentrations used for calculating the ratios are expressed with the same units and are preferably determined with the same method. Advantageously, the method for deacidifying, neutralizing or alkalinizing a starting liquid or fluid acid dairy composition according to the invention allows preserving lactose or minimizes lactose consumption. Accordingly, the method according to the invention is preferably a method for deacidifying, neutralizing or alkalinizing a starting liquid or fluid acid dairy composition while preserving lactose or minimizing lactose consumption.

Preferably the deacidified, neutralized or alkalinized liquid or fluid acid dairy composition according to the invention comprises lactose at a concentration of at least 0.5 g/100 g, 1 g/100 g, 1.5 g/100 g, 2 g/100 g, 2.5 g/100 g, 3 g/100 g, 3.5 g/100 g, 4 g/100 g, or 4.5 g/100 g. Preferably also the deacidified, neutralized or alkalinized liquid or fluid acid dairy composition according to the invention comprises lactose at a concentration lower than 10 g/100 g, 9 g/100 g, 8 g/100 g, 7 g/100 g, 6 g/100 g, or 5 g/100 g.

Preferably the ratio of the Dornic degree of the deacidified, neutralized or alkalinized liquid or fluid acid dairy composition according to the invention to the Dornic degree of the starting liquid or fluid acid dairy composition is lower than 0.8, 0.7, 0.6, 0.5, 0.4, 0.3, 0.2, 0.15, 0.1 or 0.05.

Preferably the Dornic degree (° D) of the deacidified, neutralized or alkalinized liquid or fluid acid dairy composition according to the invention is lower than 30° D, 25° D, 20° D, 15° D, 10° D or 5° D.

Preferably the ratio of the concentration of lactose to the concentration of lactic acid (expressed in the same units) is increased in the deacidified neutralized or alkalinized liquid or fluid acid dairy composition with respect to the starting liquid or fluid acid dairy composition.

Preferably the deacidified, neutralized or alkalinized liquid or fluid acid dairy composition according to the invention comprises less than 107 g/L, more preferably less than 100 g/L, and most preferably less than 90 g/L of yeast under dried form.

### Treating Steps

Optionally, a step of centrifugation of the starting liquid or fluid acid dairy composition is performed before step b) in order to remove remaining lactic acid bacteria. By way of example this centrifugation step may be carried out at 5000 rpm during

Preferably, inoculation in step b) according to the invention is performed with at least 10, 10², 10³, 10⁴, 10⁵ or 10⁶ CFU/mL of yeast. Preferably also inoculation in step b) according to the invention is performed with less than 10⁹, 10⁸ or 10⁷ CFU/mL of yeast. CFU means “colony forming unit”. Besides, as should be clear to one of skill in the art, CFU/ml refers to the number of CFU inoculated per mL of the starting liquid or fluid acid dairy composition according to the invention. As should also be clear to one of skill in the art the starting liquid or fluid acid dairy composition may be inoculated by several different strains or species of yeasts.

As should be clear to one of skill in the art step c) is preferably carried out under conditions such that the inoculated yeasts can grow, i.e. multiply, and/or reduce the concentration of lactic acid in the liquid or fluid acid dairy composition according to the invention. Advantageously, no growth additive is added to the liquid or fluid acid dairy composition according to the invention. However, in a particular embodiment of the invention a nitrogen source is added to the liquid or fluid acid dairy composition according to the invention. Preferably step c) is carried out under aerobic conditions, in particular by injecting air or a gas mixture comprising from 1% to 100% O₂ in the liquid or fluid acid dairy composition More preferably step c) is carried out with a quantity of dissolved oxygen in the liquid or fluid acid dairy composition of at least 1, 5, 10, 15 or 20 ppm. Preferably also step c) is carried out under stirring or shaking. Preferably, incubation is carried out for at least 12 h, 24 h, 36 h or 48 h. Preferably also incubation is carried out for less than 72 h, 48 h, 36 h, 24 h or 12 h.

### Yeast

As intended herein a yeast means a fungus which asexual growth predominantly results from budding or fission, and which does not form its sexual states within or upon a fruiting body.

Preferably the yeast according to the invention is of a genus selected from the group consisting of Candida, Debaryomyces, Saccharomyces, Kluyveromyces, Pichia, Torulopsis and Yarrowia. More preferably the yeast according to the invention is of a genus selected from the group consisting of Candida, Debaryomyces, and Saccharomyces. Most preferably the yeast according to the invention is of the Candida genus.

Preferably the yeast is of a species selected from the group consisting of Candida utilis, Debaryomyces hansenii, Saccharomyces cerevisiae, Kluyveromyces lactis and Yarowia lipolitica. More preferably, the yeast is of a species selected from the group consisting of Candida utilis, Debaryomyces hansenii and Saccharomyces cerevisiae. Most preferably, the yeast is Candida utilis.

By way of example, the following trains can be used according to the invention:
Candida utilis: “CHOOZIT CUM LYO 10D®” from DANISCO®.
Saccharomyces cerevisiae: Dry baker's yeast “SAF INSTANT®” from LESAFFRE®.
Debagomyces hansenii: “CHOOZIT DH LYO 10D®” from DANISCO®.
Kluyveromyces lactis: “CHOOZIT KL71 LYO 10D®” from DANISCO®.

### Use of the Deacidified, Neutralized or Alkalinized Liquid or Fluid Acid Daily Composition

As intended herein, the deacidified, neutralized or alkalinized liquid or fluid acid composition according to the invention may be further treated, in particular purified, fractionated, concentrated or crystalized, before being used. In this regard the deacidified, neutralized or alkalinized liquid or fluid acid composition according to the invention may be used as such or under dry form, e.g. in the form of a lactose powder.

According to the invention, the deacidified, neutralized or alkalinized liquid or fluid acid composition as defined above may be used in the manufacture of a food product.

As should be clear to one of skill in the art, the deacidified, neutralized or alkalinized liquid or fluid acid composition according to the invention may in particular be used in the manufacture of food products for which one or more of the components of the composition are required or advantageous, in particular lactose, calcium, yeasts or yeast proteins.

As intended herein, the deacidified, neutralized or alkalinized liquid or fluid acid composition according to the invention may be used directly as a food product or as an ingredient or intermediate in the manufacture of a food product.

Besides, the food product may be intended for animal, in particular cattle, or human, in particular baby or infant, consumption.

By way of example, the deacidified, neutralized or alkalinized liquid or fluid acid composition according to the invention may in particular be used in the manufacture of confectionery, in particular chocolate or pralines, of pastries, of bread, of bakeries, of meat products, in particular processed meat products, of baby foods, in particular dairy baby foods, such as infant milk, or of dairy products, in particular fermented dairy products.

Where fermented dairy products are considered, the deacidified, neutralized or alkalinized liquid or fluid acid composition according to the invention may notably be useful to sustain or favor the growth of the fermentative bacteria, in particular the lactic acid bacteria, notably when the milk-based composition to be fermented is depleted in lactose.

As used herein, a “lactic acid bacterium” is a Gram-positive, acid-tolerant, generally non-sporulating and non-respiring, either rod- or cocci-shaped bacterium that is able to ferment sugars into lactic acid.

As used herein the term “fermented dairy” shall be taken to mean a product or composition that is the product of the acidifying fermentation of a milk-based composition by a starter culture of fermenting microorganisms, in particular bacteria, preferably lactic acid bacteria. As used herein the term “fermented milk” shall be taken to mean a product or composition derived from milk by the acidifying action of at least one lactic acid bacterium.

Accordingly, as used herein a fermented dairy product can thus be a fermented milk, such as a yoghurt (e.g. a set, stirred or drink yogurt), or a fresh cheese such as a white cheese or a “petit-suisse”. It can be also be a strained fermented milk such as a strained yoghurt (e.g. a concentrated or Greek-style yoghurt). As used herein the term “strained fermented milk” shall be taken to mean a fermented dairy composition which has been subjected to a post-fermentation acid whey separation process.

The terms “fermented milk” and “yogurt” or “yoghurt” are given their usual meanings in the field of the dairy industry, that is, products suitable for human consumption and originating from acidifying lactic fermentation of a milk substrate. These products can contain secondary ingredients such as fruits, vegetables, sugar, etc. The expression “fermented milk” may be used to refer to fermented milks other than yogurts e.g. “Kehr”, “Kumtss”, “Lassi”, “Dahi”, “Leben”, “Filmjolk”, “Villi”, “Acidophilus milk”.

The term “yogurt” or “yoghurt” as used herein shall be taken to mean fermented milk obtained by the acidifying lactic fermentation of specific thermophilic lactic acid bacteria such as Lactobacillus bulgaricus (also referred to as Lactobacillus delbrueckii subsp. bulgaricus) and Streptococcus thermophilus (also referred to as Streptococcus salivarius subsp. thermophilus), which must be in the living state in the finished product at a minimum CFU. In certain countries, regulations allow the addition of further lactic acid bacteria to yoghurt such as but not limited to strains of Bifidobacterium and/or Lactobacillus acidophilus and/or Lactobacillus casei. These additional lactic acid bacteria strains are intended to impart various properties to the finished product, such as that of providing organoleptic qualities, favoring equilibrium of intestinal flora or modulating the immune system.

Advantageously, the deacidified, neutralized or alkalinized liquid or fluid acid composition according to the invention may provide for organoleptic enrichment of the food product, in particular by imparting a milk taste to the food product. In addition, where the food product is a fermented food product, the composition according to the invention may be fermented to yield aromatic compounds, such as diacetyl.

More generally, the deacidified, neutralized or alkalinized liquid or fluid acid composition as defined above according to the invention may also be used for the production of aromas, in particular by fermentation.

Where the present invention relates to the use of a deacidified, neutralized or alkalinized liquid or fluid acid composition as defined above as a culture medium, in particular a bacterial culture medium, the composition is especially useful for the culture of lactic acid bacteria. It may also be used for the culture of methanogenic bacteria. As such, the composition according the invention may be used as a substrate in methanization processes and is thus useful in energy production.

The deacidified, neutralized or alkalinized liquid or fluid acid composition according to the invention may comprise phosphate and may thus be used as a fertilizer.

The fibers produced from the deacidified, neutralized or alkalinized liquid or fluid acid composition according to the invention are in particular polygalactose fibers, comprising from 5 to 10 galactose units, or galacto-oligosaccharides (GOS). GOS can be defined as mixtures of those substances produced from lactose, comprising between 2 and 8 saccharide units, with one of these units being a terminal glucose and the remaining saccharide units being galactose and disaccharides comprising 2 units of galactose.

Regarding the pharmaceutical applications of the deacidified, neutralized or alkalinized liquid or fluid acid composition according to the invention, the composition may notably be used as an excipient of tablets and, in finely granulated form, as a carrier of medicines in dry powder inhalation preparations.

The invention will be further described by the following non-limiting Example.

### Example

### Materials & Methods

### Strains:

Saccharomyces cerevisiae: Dry baker's yeast “SAF INSTANT®” batch no 092015CLR from LESAFFRE® bought at “Moulins de Versailles CHAUDE frères”, Versailles France.
Debaryomyces hansenii: “CHOOZIT DH LYO 10D®” batch no 4412430306 from DANISCO®
Candida utilis: “CHOOZIT CUM LYO 10D®” batch no 4412419039 from DANISCO®

### Acid Wheys

Two acid wheys (1 and 2) were used. Acid whey 1 was obtained from dairy processes involving lactic acid fermentation of milk. Acid whey 2 was obtained by nano-filtration from acid whey 1 and was diluted to yield a lactose concentration as close as possible as that of acid whey 1.

| | | | | Protein | ΔOptical | Dry |
|---|---|---|---|---|---|---|
| Acid | | Lactose | Lactic Acid | (ntx6.38 | density | matter |
| whey | pH | (g/100 g) | (mg/100 g) | in %) | (620 nm) | (%) |
| Acid | 4.2 | 3.72 | 750 | 0.4 | 0 (baseline) | 6.4 |
| whey 1 | | | | | | |
| Acid | 4.4 | 3.92 | 433 | 0.38 | 0 (baseline) | 6.2 |
| whey 2 | | | | | | |

### Method

Acid whey was first centrifuged at 5000 rpm during 15 minutes to remove any lactic acid bacteria liable to perform an alternative fermentation.

200 mL of acid whey were inoculated by 10⁶ CFU/ml of yeast and incubated in DASGIP© Benchtop Bioreactors for Cell Culture (Eppendorf).

The culture conditions were as follows: 26° C. under stirring at 300 rpm, with air injection. The culture was performed during 24 hours or from 40 to 48 hours.

pH and optical density were measured during incubation. Analysis of lactic acid content was performed by HPLC coupled with refractometry, and analysis of lactose content was performed by an HPLC pursuant to AOAC Official Method 984.12, at the beginning and the end of the incubation.

### Results

The results are provided in the following Table:

| | | | | ΔLactic | ΔOptical |
|---|---|---|---|---|---|
| | | | ΔLactose | Acid | density |
| Yeast | Whey | ΔpH | (%) | (mg/100 g) | (620 nm) |
| Saccharomyces | Acid | +0.42 | 0 | −100 | +15 |
| cerevisiae | whey 1 | | | | |
| Debaryomyces | | +0.93 | 1 | −57 | +30 |
| hansenii | | | | | |
| Candida utilis | | +4.03 | 0 | −708 | +41 |
| Saccharomyces | Acid | +0.95 | 10 | −253 | +14 |
| cerevisiae | whey 2 | | | | |

ΔLactose (%) represents the percentage of lactose which has been consumed by the yeasts

It can be seen that yeasts can grow in acid whey. This growth is associated to a decrease of the concentration of lactic acid without a significant decrease of the concentration of lactose. The decrease of the concentration of lactic acid is correlated to pH increase, deacidification or alkalization of acid whey.

1. A method for deacidifying, neutralizing or alkalinizing a starting liquid or fluid acid dairy composition, comprising:
a) providing a liquid or fluid acid dairy composition comprising lactic acid;
b) inoculating the composition with at least one yeast;
c) incubating the inoculated composition;
d) recovering a deacidified, neutralized or alkalinized liquid or fluid acid dairy composition with a reduced concentration of lactic acid.

2. The method according to claim 1, wherein the starting composition comprises lactic acid at a concentration higher than 300 mg/100 g.

3. The method according to claim 1, wherein the ratio of the concentration of lactic acid in the deacidified, neutralized or alkalinized composition to the concentration of lactic acid in the starting composition is lower than 0.7.

4. The method according to claim 1, wherein the deacidified, neutralized or alkalinized liquid or fluid acid dairy composition comprises lactic acid at a concentration lower than 200 mg/100 g.

5. The method according to claim 1, wherein the pH of the starting composition is lower than 5.0.

6. The method according to claim 1, wherein the pH of the deacidified, neutralized or alkalinized composition is at least 0.5 pH unit above the pH of the starting composition.

7. The method according to claim 1, wherein the ratio of the concentration of lactose in the deacidified, neutralized or alkalinized composition to the concentration of lactose in the starting composition is higher than 0.8.

8. The method according to claim 1, wherein step c) is carried out under aerobic conditions.

9. The method according to claim 1, wherein the starting liquid or fluid acid dairy composition is selected from the group consisting of acid whey, a stirred yogurt, a liquid yogurt, and a fermented dairy drink.

10. The method according to claim 1, wherein the starting liquid or fluid acid dairy composition is acid whey.

11. The method according to claim 1, wherein the yeast is of a genus selected from the group consisting of Saccharomyces, Debaryomyces, Kluyveromyces and Candida.

12. The method according to claim 1, wherein the yeast is Debaryomyces hansenii or Candida utilis.

13. The use of a yeast as defined in claim 1 for deacidifying, neutralizing or alkalinizing a starting liquid or fluid acid dairy composition as defined in claim 1 by reducing lactic acid concentration.

14. A liquid or fluid dairy composition comprising at least one yeast selected from the group consisting of Debaryomyces hansenii and Candida utilis, lactic acid at a concentration lower than 200 mg/100 g and lactose at a concentration higher than 1 g/100 g.

15. The liquid or fluid acid dairy composition according to claim 14, wherein the liquid or fluid dairy composition is deacidified, neutralized or alkalinized acid whey.
